(19) United States
(12) Patent Application Publication
(10) Pub. No.: US 2007/0190922 A1
(43) Pub. Date: Aug. 16, 2007

(54) NBC-protection and decontamination system

(76) Inventors: Karl-Hans Fuchs, Zikhron Yaaqov (IL); Samuel Weidner, Zikhron Yaaqov (IL); Andreas Koeger, Zikhron Yaaqov (IL); Jonathan Schneider, Zikhron Yaaqov (IL)

Correspondence Address: JACOBSON HOLMAN PLLC, 400 SEVENTH STREET N.W., SUITE 600, WASHINGTON, DC, 20004, US

(21) Appl. No.: 11/245,439

(22) Filed: Oct. 7, 2005

(30) Foreign Application Priority Data
Oct. 10, 2004 (IL) 164,457

(51) Int. Cl. B01L 1/04

(52) U.S. Cl. 454/187

(57) ABSTRACT

There is provided an NBC protection and decontamination system, including an enclosure, an airlock, an airlock compartment, having a ceiling, and including a back-flow collector, an air filtration unit, a compartment inlet valve communicating with the air outlet of the enclosure, an exit valve being provided in the compartment and spaced apart from the compartment inlet valve, and an opening providing controllable passage between the enclosure and the airlock, and an opening providing controllable passage between the airlock and the outside, wherein the airlock compartment is swept by two different airflows, a first airflow originating in the enclosure and a second airflow produced by the filtration unit.

### FIELD OF THE INVENTION

The present invention relates to an NBC—protection and decontamination system and a method for ensuring effective NBC—protection and decontamination.

### BACKGROUND OF THE INVENTION

As is known, the need for collective protection has recently increased, due to international military deployments and acts of terror, using methods and components of chemical or biological warfare. As a contamination-protected space, hereinafter called a Toxic Free Area or TFA, is always enclosed and personnel must be able to enter and leave a mobile shelter or tent without harming the atmosphere within, a common method to facilitate entry and exit is to use an airlock or a sequence of chambers as Contamination Control Area. Such airlocks should effectively prevent any cross-contamination of the TFA from outside, and—in case of a CCA—facilitating decontamination.

To date, the dwell times of airlocks or CCA's for which one has to stay in the chamber until the contamination dosage has been reduced to a tolerable level, are relatively long. This limits not only the number of entries/exits, but also imposes significant delays, thus handicapping or disabling any swift entry to the TFA, a major set back in particular for command & control posts or mobile field hospital facilities.

The term “decontamination”, which means to get rid of a polluting or harmful substance, is also used today to include, or instead of, the term “flushing”. Thus, the term “decontamination” should be interpreted throughout this specification to also mean “flushing”.

### DISCLOSURE OF THE INVENTION

It is therefore a broad object of the present invention to ameliorate the above-described and other disadvantages of prior art systems and to provide adequate dosage reduction and a method for protecting enclosed spaces against the penetration of contaminated, hazardous fluids and/or particles.

It is a further object of the present invention to provide an airlock capable of serving as a decontamination unit and attachable to the walls of an enclosed space to be protected against penetration of contaminated, hazardous fluids and/or particles.

It is yet another object of the invention to provide movement or proximity sensors to start, and in combination with timers and chemical sensors, to end the operation of the blower and air filtration unit, and indicate when a person can leave the airlock and enter the main space.

It is still another object of the invention to provide for the use of elevated temperatures in the airlock in order to accelerate the evaporation of the warfare chemicals so that they can be absorbed to the filter system.

This is achieved by the present invention by an NBC protection and decontamination system, comprising an enclosure defining a space, serving as toxic-free area, said enclosure having at least one clean-air inlet port and at least one air outlet; at least one airlock serving as decontamination unit at the outside of said enclosure and containing, in an air-and-warfare-agent-tight configuration; an airlock compartment, having a ceiling, and including a back-flow collector; at least one air filtration unit using a blower drawing air from said backflow collector through at least one filter element, and forcing said air into a space upstream of said airlock compartment; at least one compartment inlet valve communicating with the air outlet of said enclosure; at least one exit valve being provided in said compartment and spaced apart from said compartment inlet valve, and an opening providing controllable passage between said enclosure and said airlock, and an opening providing controllable passage between said airlock and the outside, and characterized in that said airlock compartment is swept by two different airflows, a first, continuous airflow originating in said enclosure and a second, intermittent airflow produced by said filtration unit.

The invention further provides an NBC protection and decontamination method comprising the steps of: providing a system as claimed in claim 1; introducing a continuous flow from said enclosure into said decontamination compartment, to pass said compartment from the air-inlet valve thereof towards the air exit valve thereof, and introducing an intermittent flow of air from said filtration unit into said decontamination compartment to exit said compartment via said back-flow collector.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purpose of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of the system according to the invention;

FIG. 2 is a representation, to a larger scale, of the airlock of FIG. 1;

FIG. 3 schematically shows the arrangement of the filtration unit;

FIG. 4 illustrates airflow A as it passes the airlock;

FIG. 5 shows airflow B as it circulates in the airlock;

FIG. 6 illustrates the backflow collector, and

FIG. 7 is a schematic drawing of a multi-stage system.

### DETAILED DESCRIPTION OF THE PREFERRED EMBODIMENTS

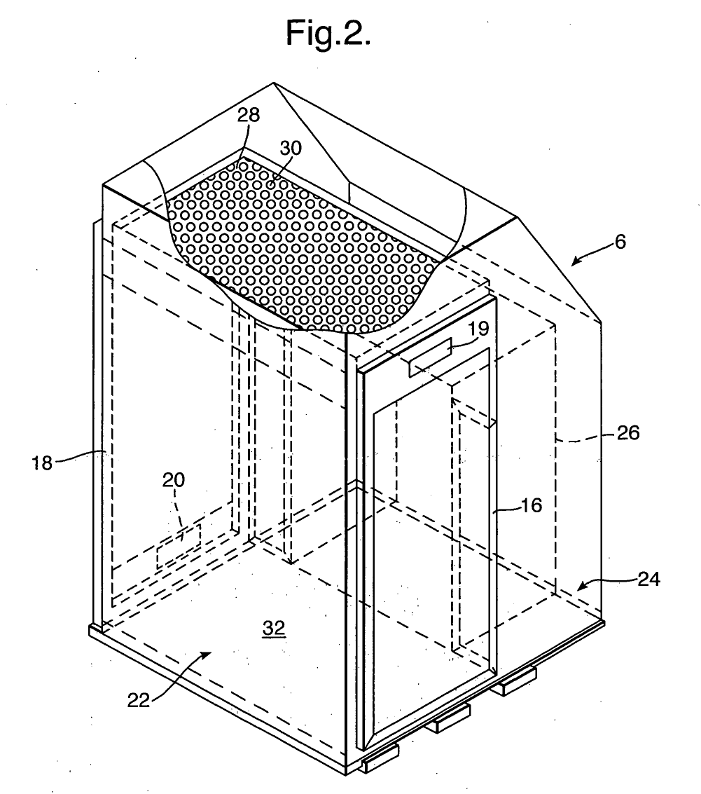

Referring now to the drawings, there is shown, in a schematic representation, the NBC-protection and decontamination system according to the invention, seen as a covered enclosure 2 which may be a collapsible tent or a similar structure having fluid and air-tight walls and surfaces made of a flexible material, or an enclosure made of semi-rigid material, or a combination of such materials. This enclosure defines a toxic-free area (TFA) or space 4. The front wall of enclosure 2 is fitted with an airlock/contamination control area (CCA), hereinafter, for brevity, denoted as airlock 6, and may also include a normally closed door 8. Mechanically and chemically filtered air from filters 10 on the outside enters the TFA through one or more air inlet ports 12 and flows via manifolds 14 in direction of front wall 15, where airlock unit 6 is situated. Normally closed utility sleeves 13, for the entry of various piping, such as electric cables, water pipes, and the like, may also be provided. Enclosure 2 is also provided with an air outlet (not shown) near the upper edge of front wall 15 which when airlock 6 is attached, comes to be so located as to register with air inlet valve 19 of airlock 6 (FIG. 2).

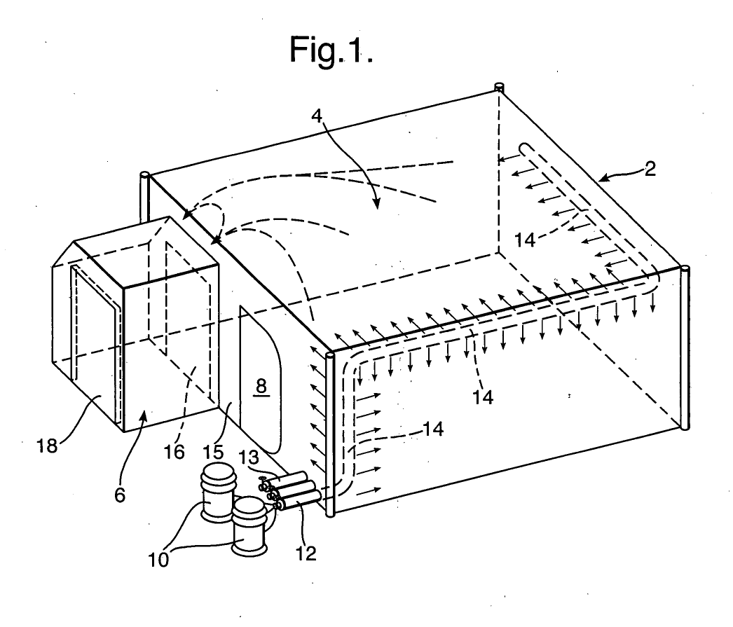

Airlock 6, shown to a larger scale and in greater detail in drawings to follow, consists of a chamber defined by walls and surfaces, and being tightly attachable to front wall 15 of enclosure 2. Airlock 6 has two controllable openings or doors, one door, 16, controlling the passage between airlock 6 and enclosure 2, the other door, 18, controlling the passage between airlock 6 and the outside, or, in a multistage embodiment discussed further below, the passage between airlock 6, and a further stage. It will be appreciated that in the system embodiment illustrated in FIGS. 1-5, decontamination in airlock 6 is effected by air flushing only.

FIG. 2 is a representation to a larger scale of airlock 6 of FIG. 1. At least some of the walls and surfaces of airlock 6 consist of a flexible advantageously transparent material which is warfare agent resistant, fire retarded and stress-resistant, and will retain these properties over a temperature range of at least −20° to +55° C. These walls and surfaces are rigidified by lightweight structures (not shown).

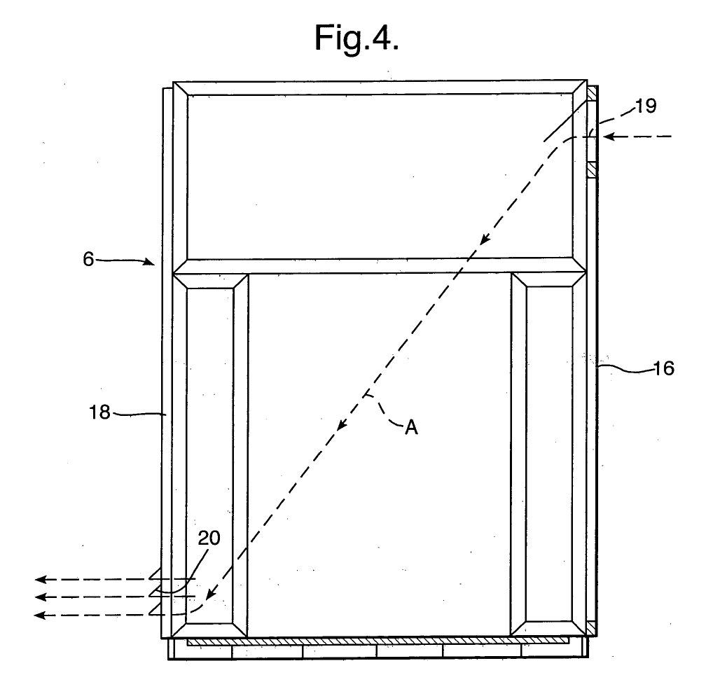

Also shown are doors 16 and 18, the functions of which have been explained above. Door 16 is provided with an adjustable overpressure inlet valve 19 near the upper door edge which, when airlock 6 is attached to enclosure 2 (as shown in FIG. 1), is intended to register with the above-mentioned air outlet of enclosure 2. Door 18 is also provided with a similar valve 20 serving as outlet or exit valve which, however, is located near the lower edge of door 18. The relative locations of valves 19 and 20 produce a continuous airflow, designated airflow A, which is part of the decontamination process of airlock 6 and, as illustrated in FIG. 4, is seen to cross airlock 6 in a diagonal direction, from valve 19 to valve 20.

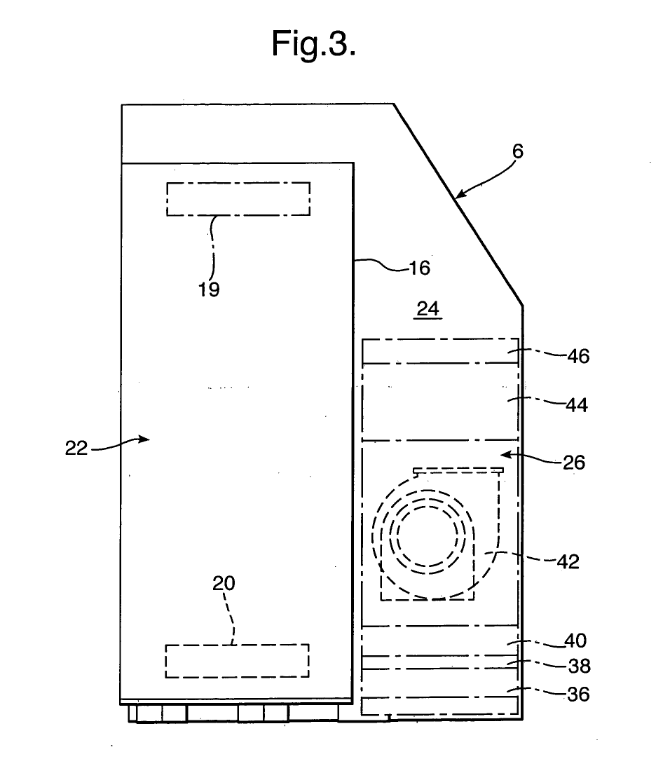

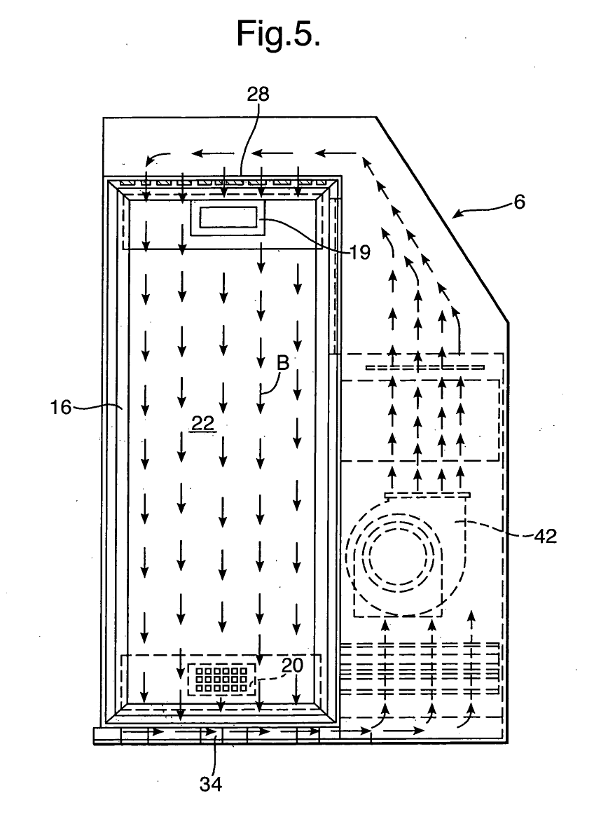

As seen in FIG. 2, and even more clearly in FIG. 3, airlock 6 is subdivided into two separate compartments, the decontamination compartment 22 through which passes personnel from the outside to be decontaminated before entering enclosure 2, and the filtration compartment 24 which accommodates filtration unit 26 which comprises a blower, various filters, sensors, etc., as will be explained in conjunction with FIG. 3. Compartments 22 and 24 communicate only through laminator 28, the ceiling of compartment 22 and through its floor 32. The aim of laminator 28 is to produce a laminary, vertical airflow, designated airflow B in FIG. 5, and it consists of a panel of a thickness of about 0.8 mm, having a plurality of small perforations 30, the total sum of the area of which is less than 40% of the area of the laminator.

Floor 32 has a lattice-like surface 33 that covers an air backflow collector 34 (FIG. 5), a low space through which decontamination compartment 22 communicates with filtration unit 26. The particular importance of backflow collector 34 resides in the fact that the majority of warfare agents have a density higher than the density of air and, without collector 34, would remain in corners of the lower part of compartment 22.

While airflow A, which delivers about 100 cfm, operates continuously, at least as long as enclosure 2 is in use, airflow B which delivers about 1200 cfm, acts intermittently, being switched on as soon as a person enters airlock 6 and switched off as soon as contamination has reached a level below a critical threshold as indicated by a chemical sensor. Timers may be used as well. The presence of personnel may be sensed by a movement or proximity sensor, or both.

While in the embodiment illustrated in FIGS. 1 to 6, the direction of airflow A is seen to differ from the direction of airflow B, best results would be obtained in configurations in which the direction of airflow B would be as close as possible to that of airflow A.

Since the warfare agents may be in the form of liquid particles or may be absorbed by the protective clothing, increased temperature can be applied to accelerate evaporation of these chemicals and to absorb them at an activated-carbon filter that is part of the filtration unit. A heating unit for this purpose obviously requires a thermostat.

FIG. 3 represents airlock 6 as seen in direction of inner door 16, behind which extends decontamination compartment 22. Indicated are inlet valve 19 in door 16 and outlet or exit valve 20 in door 18 (not seen). Filtration unit 26, clearly seen here as separated from decontamination compartment 22, accommodates, starting from bottom, some or all of the above-mentioned sensors, a pre-filter 38, a high efficiency (HEPA) filter 40, a blower 42, an adsorption filter 44 and a heating unit 46. A cooling system is optional.

FIG. 4 illustrates schematically the above-described airflow A, while FIG. 5 depicts the above-described airflow B, indicating also the position of back-flow collector 34.

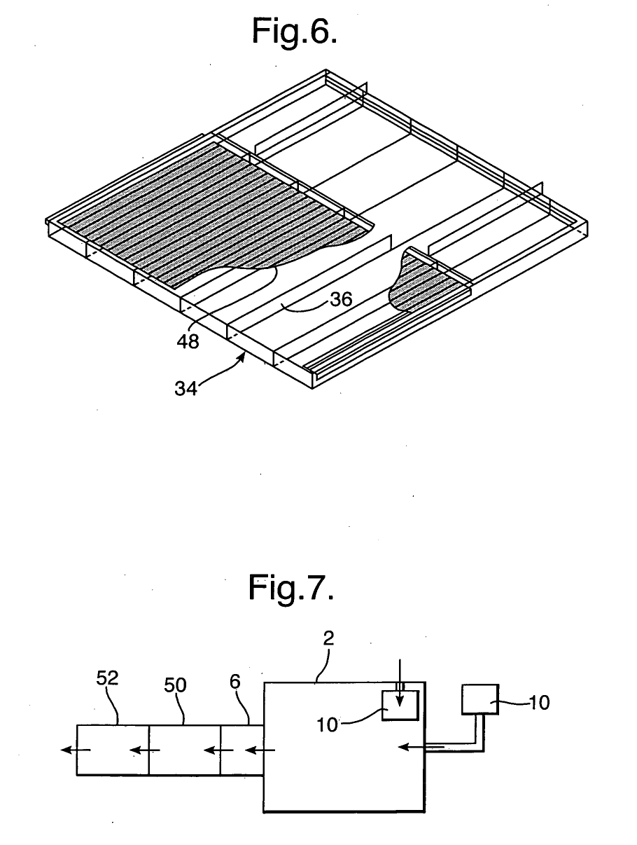

FIG. 6 shows the back-flow collector 34, which constitutes the lowermost component of airlock 6. The ribbing 36 supports the relatively thin grid 48.

The embodiment of the airlock illustrated in the Figures relates to a personnel airlock, having a length (door 16 to door 18) of 1.5 m. Airlocks designed to accommodate also stretchers are about twice as long.

The present invention envisages also a multi-stage configuration as schematically depicted in FIG. 7 which shows enclosure 2, air filter units 10 and airlock 6, with which are series-connected two more airlocks 50 and 52. The arrows signify the direction of air flow. Entrance into enclosure 2 begins at airlock 52, which is designed to deal mainly with liquid contaminants by showering the person with water or with solutions of certain chemicals. In airlock 50 the person changes clothing and, sometimes, showers again. After that, the person enters enclosure 2 via airlock 6.

Pressure drop gradient along airlocks 6, 50 and 52 is advantageously about 50 Pa per airlock.

It was noted that it would be beneficial for isolation purposes, where the RFU filtration system is combined with valves that split the airstream after the RFU filter, e.g., 80% will recycle and 20% will be pushed outside. The missing 20% will be drawn out of an isolation space and will provide therein negative pressure and airflow.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An NBC protection and decontamination system, comprising:
an enclosure defining a space, serving as toxic-free area, said enclosure having at least one clean-air inlet port and at least one air outlet;
at least one airlock serving as decontamination unit at the outside of said enclosure and containing, in an air-and-warfare-agent-tight configuration:
an airlock compartment, having a ceiling, and including a back-flow collector;
at least one air filtration unit using a blower drawing air from said backflow collector through at least one filter element, and forcing said air into a space upstream of said airlock compartment;
at least one compartment inlet valve communicating with the air outlet of said enclosure;
at least one exit valve being provided in said compartment and spaced apart from said compartment inlet valve, and an opening providing controllable passage between said enclosure and said airlock, and an opening providing controllable passage between said airlock and the outside, and
characterized in that said airlock compartment is swept by two different airflows, a first airflow originating in said enclosure and a second airflow produced by said filtration unit.

2. The system as claimed in claim 1, wherein said first airflow is continuous as long as said enclosure is in operation, and said second airflow is intermittent, being switched on when a person enters said airlock and being switched off when said airlock is left empty of personnel.

3. The system as claimed in claim 1, further comprising an airflow laminator.

4. The system as claimed in claim 3, wherein said air laminator constitutes part of a surface on the upstream side of said intermittent airflow.

5. The system as claimed in claim 3, wherein said air laminator constitutes the ceiling of said airlock compartment.

6. The system as claimed in claim 1, wherein said back-flow collector constitutes the floor of said airlock compartment.

7. The system as claimed in claim 1, wherein said back-flow collector is located on part of a surface on the downstream side of said intermittent air.

8. The system as claimed in claim 1, wherein said NBC filtration unit is triggered by a movement sensor and/or by an NBC detector sensor.

9. The system as claimed in claim 1, wherein said NBC filtration unit includes a heating system and/or a cooling system.

10. The system as claimed in claim 1, wherein said system comprises walls and surfaces at least some of which are made of flexible material.

11. The system as claimed in claim 3, wherein said laminator is formed by a plurality of small apertures distributed over at least a portion of said ceiling or said surface.

12. The system as claimed in claim 11, wherein the sum of the areas of said small apertures is less than 40% of the total surface of said laminator.

13. The system as claimed in claim 10, wherein said flexible material is transparent, warfare-agent resistant, fire-retarded and stress resistant at least between −20° and +55° Celsius.

14. The system as claimed in claim 1, wherein said openings are closeable and openable doors.

15. The system as claimed in claim 1, wherein said at least one filter element is a HEPA filter.

16. The system as claimed in claim 1, further comprising an activated-carbon filter.

17. The system as claimed in claim 1, wherein said system comprises a plurality of series-connected airlock compartments.

18. The system as claimed in claim 17, wherein at least one of said plurality of airlock compartments is adapted to deal at least with liquid contaminants and at least another one of said compartments at least with vaporous contaminants.

19. An NBC protection and decontamination method comprising the steps of: providing a system as claimed in claim 1;
introducing a continuous flow from said enclosure into said decontamination compartment, to pass said compartment from the air-inlet valve thereof towards the air exit valve thereof, and
introducing an intermittent flow of air from said filtration unit into said decontamination compartment to exit said compartment via said back-flow collector.

20. The method as claimed in claim 19, further comprising the step of laminating the intermittent flow introduced into said compartment.
